(19) United States
(12) Patent Application Publication
(10) Pub. No.: US 2018/0189901 A1
(43) Pub. Date: Jul. 5, 2018

(54) FOOD ORDER AT A DINING ESTABLISHMENT

(71) Applicants: David I. Poisner, Carmichael, CA (US); Beena More, Folsom, CA (US); Yuri I. Krimon, Folsom, CA (US)

(72) Inventors: David I. Poisner, Carmichael, CA (US); Beena More, Folsom, CA (US); Yuri I. Krimon, Folsom, CA (US)

(21) Appl. No.: 15/395,607

(22) Filed: Dec. 30, 2016

(51) Int. Cl. G06Q 50/12; G06Q 30/06; G06F 3/0488

(52) U.S. Cl. CPC G06Q 50/12; G06Q 30/0635; G06F 3/16; G06F 3/04883; G06Q 30/0641

(57) ABSTRACT

Systems, apparatuses, and/or methods to process a food order that includes suitable food for a consumer. An apparatus may include a position determiner to determine a position of a consumer at a dining establishment via a device associated with the consumer, wherein the consumer is to place an order for food from a food menu, a food characteristic data provider to provide food characteristic data for the food, and/or an order interface to render the food menu and/or input the order. The apparatus may include a position indicator to indicate the position of the consumer, a food characteristic data identifier to identify food characteristic data for the food, and/or a comparator to generate a comparison between the food characteristic data and food preferences data to determine suitable food in the order for the consumer.

### TECHNICAL FIELD

Embodiments generally relate to food ordering at a dining establishment. More particularly, embodiments relate to determining suitable food for a consumer at a dining establishment and/or processing a food order including the suitable food.

### BACKGROUND

Food tracking technologies may log nutrition intake. The food tracking technologies may not, however, relay nutrition information to a tracking application. Indeed, manual data entry of nutrition information at the tracking application may be cumbersome and/or prone to errors with various options and steps available to a user. Meals may also be tracked visually. Camera tracking technologies, however, may infer ingredients and therefore may be relatively inaccurate. In addition, there may be added inconvenience from taking a photo of a meal. Similarly, it may be inconvenient and/or esthetically displeasing to manually enter food using barcode food tracking technologies. Thus, a user may ultimately quit tracking meals as a result of errors, inconvenience, etc.

Additionally, there may be foods that a user must not eat and/or should not eat. For example, foods that a user must not eat may include user-specific foods that cause an allergic reaction and/or that are medically restricted to a user. Moreover, foods that a user should not eat may include user-specific foods that are avoided based on religions or personal preferences of a user. The user, however, may need to infer ingredients from a menu or ask a server, which may cause errors, inconvenience, etc.

Meanwhile, a food server may need to identify which specific food of an order belongs to which specific user. For example, a food server may need to query a group of users to determine who ordered specific food. Even at a fast-food establishment, there may be ambiguity as to who ordered specific food (e.g., when one patron orders for an entire party). Determining an appropriate allocation of food at a dining establishment, therefore, may be cumbersome, may be prone to errors, and so on. Thus, there is considerable room for improvement to track food intake, to determine suitable food for a consumer, to properly allocate food at a dining establishment, and so on.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1B are illustrations of an example of a system to process a food order that includes suitable food for a consumer according to an embodiment;

FIG. 2 is an illustration of an example service device and an example consumer device according to an embodiment;

FIG. 3 is an illustration of an example of a method to process a food order that includes suitable food for a consumer according to an embodiment;

FIG. 4 is a block diagram of an example of a processor according to an embodiment; and

FIG. 5 is a block diagram of an example of a computing system according to an embodiment.

### DESCRIPTION OF EMBODIMENTS

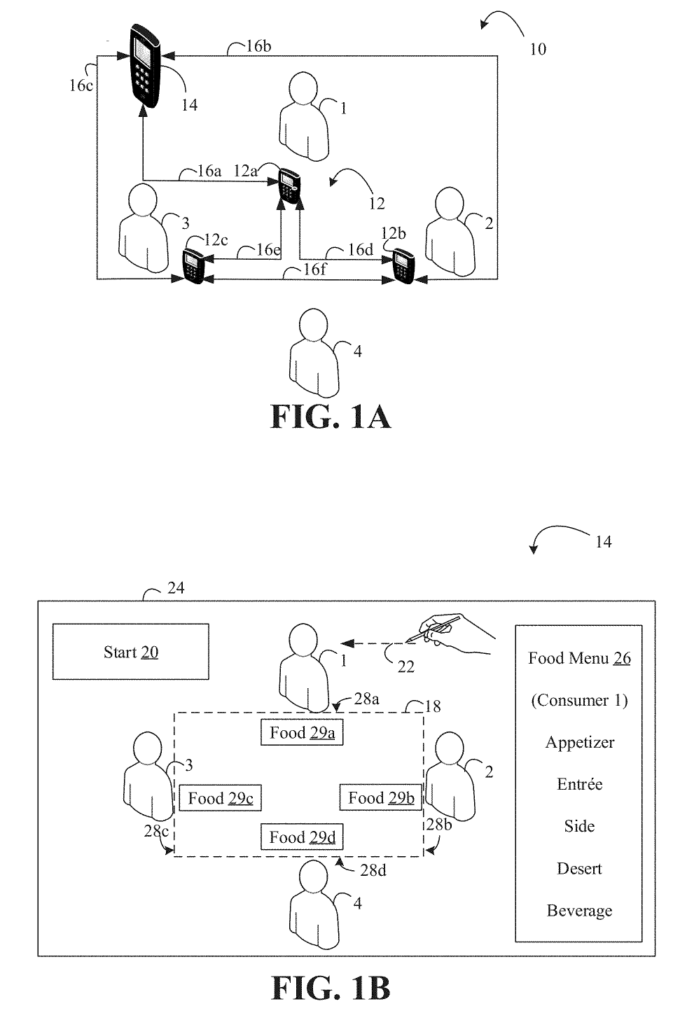

Turning now to FIGS. 1A-1B, a system 10 is shown to process a food order that includes suitable food for a consumer according to an embodiment. The consumer may include a patron physically located at a dining establishment such as a fast-food restaurant, a full-service (e.g., sit-down) restaurant, a food-court, and so on. The consumer may be associated with a device 12 (e.g., a consumer device) such as a mobile computing platform including a laptop, personal digital assistant (PDA), media content player, mobile Internet device (MID), any smart device such as a wireless smart phone, a smart tablet, a smart TV, a smart watch, smart glasses (e.g., augmented reality (AR) glasses, virtual reality (VR) glasses, etc.), a gaming platform, and so on. As shown in FIG. 1A, consumer 1 is associated with device 12a, consumer 2 is associated with device 12b, and consumer 3 is associated with device 12c. Consumer 4 is not associated with any device (e.g., no device present, no device discoverable, etc.).

Similarly, the dining establishment may be associated with a device 14 (e.g., a service/ordering device). For example, the device 14 may include a hand-held mobile computing platform, a wearable mobile computing platform, etc. In addition, the device 14 may include an actuator to implement a movement by the device 14. The actuator may include, for example, a wheel, a rail, a hinge, etc. In one example, the actuator may facilitate automatic movement by the device 14 between two or more dining areas of the establishment (e.g., between two or more tables, etc.). In another example, a kiosk (e.g., a smart cash register, a point-of-sale terminal, etc.) may be located at a common ordering area (e.g., ordering station of a fast-food restaurant, etc.) and/or at a dining area of the establishment (e.g., at a dining table of a full-service restaurant, etc.) and use the actuator to move within the area of the establishment (e.g., rotation about an axis, etc.). The device 14 may further include a fixed location, immobile computing platform, which does not automatically move between and/or within one or more areas of a dining establishment such as a kiosk located at a common ordering area that lacks an actuator.

The devices 12, 14 may include communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), LiFi (Light Fidelity, e.g., Institute of Electrical and Electronics Engineers/IEEE 802.15-7, Wireless Local Area Network/LAN Medium Access Control (MAC) and Physical Layer (PHY) Specifications), 4G LTE (Fourth Generation Long Term Evolution), Bluetooth (e.g., Institute of Electrical and Electronics Engineers/IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), and other radio frequency (RF) purposes.

Accordingly, communication among the devices 12, 14 may provide seamless distribution of nutrition information, verification that consumer preferences are met, distribution of correct food to a proper consumer, and/or minimized interactions between an employee of the establishment (e.g., waitress/waiter, etc.) and a consumer. Moreover, the devices 12, 14 may provide for an improvement to a computer itself (e.g., logic to implement one or more aspects of embodiments), an improvement to ordering technologies, an improvement to tracking technologies, an improvement to food allocation technologies, the generation and/or the transformation of data (e.g., data in a list, data in a database, data in a log, etc.), liability aversion, and so on. As shown in FIG. 1A, communication channels 16a-16f may be used to exchange position data, food characteristic data, preference data, alert data, override data, and so on.

FIG. 1B shows that the consumers 1-3 seated at a table 18 of a dining establishment may indicate their position, for example via a respective proximity sensor (e.g., Bluetooth sensor, etc.) of the devices 12a-12c. The device 14 may, for example, use position data to determine the position of the consumers 1-3 as the device 14 approaches the table 18. In one example, the device 14 may use a proximity sensor to receive the position data and may implement a triangulation technique to determine the relative position of the consumers 1-3 (e.g., to each other, to a seat position, etc.). The determination made via the device 14 may be initiated in response to satisfying a signal strength threshold for a signal from the devices 12a-12c, may be initiated in response to an initiation command at the device 14, etc. Thus, the device 14 may use the position data from the devices 12a-12c exchanged over one or more of the communication channels 16a-16f to triangulate a relatively precise position of the consumers 1-3, such as a coordinate position including an x, y Cartesian coordinate position (and a z-position for a two-story establishment, for depth, etc.), a polar coordinate position, etc.

Relatively less precise position determination techniques may also be implemented. For example, the device 14 may determine that one or more consumers are positioned in front of the device 14 and implement a relatively simple triangulation technique to determine the position of one or more of the consumers 1-3 located in front of the device 14. Image-based analysis techniques may also be implemented instead of and/or in addition to triangulation techniques or other wireless positioning techniques to determine the position of the consumers 1-3. In one example where consumers are ordering from a kiosk (e.g., kiosk implementation), a relatively simple triangulation may be used to determine what consumer is in front of the kiosk (e.g., antennas on either side of a kiosk to easily determine if there is a wireless device in front of the kiosk, etc.). To disambiguate multiple consumers in front of the kiosk, the kiosk may ask the consumers to assist in disambiguation (e.g., if within a pre-determined threshold distance, etc.). If, for example, consumers are three feet apart then the kiosk may disambiguate. If, however, consumer are inches apart then assistance may be requested to disambiguate.

Moreover, a notification may be issued that indicates an interaction with the device 14 (e.g., a point-of-sale kiosk, etc.) is to be conducted. The notification may include a visual notification (e.g., a displayed message, etc.), a tactile notification (e.g., a vibration, etc.), an audible notification (e.g., a sound, etc.), and so on. Thus, the consumers 1-3 may receive the notification via the devices 12a-12c, respectively, and/or the consumers 1-4 may receive the notification via the device 14 (e.g., a kiosk implementation, etc.) to provide an opportunity to accept the interaction, to start participating in the interaction, and so on.

The device 14 may also identify a gesture to initiate an order for food. For example, the gesture may include a point gesture (e.g., point in a direction of a start icon, point in a direction of a table, etc.), a touch gesture (e.g., touch a start icon on a display, touch a table on a display, etc.), an audible gesture (e.g., vocalize a start command, etc.), a gaze gesture (e.g., gaze by a user pupil and/or by camera, e.g., at a table for a predetermined amount of time, etc.), a motion gesture (e.g., movement of a device below a predetermined motion value, etc.), and so on. The device 14 may also identify a gesture to select a specific consumer that is to place an order (e.g., that makes an order, that is to make an order, etc.). For example, the device 14 may identify a point gesture (e.g., point in a direction of a specific consumer, etc.), a touch gesture (e.g., touch an object on a display that represents a specific consumer, etc.), an audible gesture (e.g., vocalize identification information for a specific consumer such as a seat location, a numerical label for a specific consumer, etc.), a gaze gesture (e.g., gaze by a user pupil and/or by a camera, e.g., at a specific consumer for a predetermined amount of time, etc.), a motion gesture (e.g., movement of a device in a direction of a specific consumer, etc.), and so on.

As shown in FIG. 1B, a start icon 20 is selected to initiate an order for the table 18, and the device 14 identifies a gesture 22 that includes a swipe in a direction toward the consumer 1. In one example, an employee of the dining establishment selects the start icon 20 and makes the gesture 22 on a display 24 of the device 14 when the consumer 1 begins to order food. The gesture 22 may be made, however, before or after the consumer 1 begins to place the order. In this regard, the employee of the dining establishment may use a finger and/or a stylus to input one or more gestures via the display 24. Based on a particular implementation, however, a consumer may input one or more gestures via the device 14 (e.g., a kiosk implementation, etc.) to place an order.

In the illustrated example, the device 14 displays a food menu 26 on the display 24 (e.g., LCD, LED, transparent display, etc.) of the device 14. In one example where the food menu 26 is rendered before food characteristic data and/or preference data is shared, the food menu 26 may include all food options available at the dining establishment independent of consumer preferences. In another example where the food menu 26 is rendered after food characteristic data and/or preference data is shared, the food menu 26 may include only food options that are available to a specific consumer based on consumer preferences. In either case, the device 14 may be used to link specific food of the order with the consumer 1. For example, the device 14 may be used to associate food selected using the food menu 26 with the consumer 1 selected using the gesture 22.

Accordingly, the device 14 may automatically share food characteristic data for all of the food available in the food menu 26, for food corresponding to the order by the consumer 1, etc. The food characteristic data may include, for example, ingredient information (e.g., all ingredients used to prepare the food in the food menu 26, all ingredients used to prepare the food that has been ordered by the consumer 1), caloric information for the food, nutrition information (e.g., protein level, fat level, carbohydrate level, ion level, dairy level, etc.), spice information (e.g., spice level, etc.), temperature information (e.g., current temperature, typical serving temperature, etc.), cooking style information (e.g., grill, bake, fry, etc.), and so on. Thus, the food characteristic data may include nutrition data, ingredient data, food property data (e.g., temperature, spice level, cooking style, etc.), and so on. In addition, the food characteristic data may be accessible from a cloud-computing server (e.g., via an application programming interface (API), etc.), from local memory, from local storage, and so on.

In addition, the food characteristic data may be compared to food preference data, which may also be accessible from a cloud-computing server, from local memory, from local storage, and so on. For example, a list of food preferences may include a list of ingredients that a consumer must not eat (e.g., a food and/or a drink that is an allergen, that is medically restricted, etc.), a list of ingredients that a consumer does not prefer to eat (e.g., a food and/or a drink that is not preferred based on religions prohibitions, personal preference, etc.), caloric information related to ingredients a consumer must not and/or should not eat, nutrition requirement/preference (e.g., protein requirement, vitamin requirement, etc.), spice level requirement/preference (e.g., a preference to not eat any food classified as “spicy”, food that satisfies a predetermined spice level, etc.), temperature level requirement/preference (e.g., a preference to not eat food classified as “cold” due to a dental restriction, a preference to not eat a specific food that is too cold such as cold soup, etc.), and so on. Thus, the list of food preferences may include nutrition data, ingredient data, property data (e.g., temperature, spice level, cooking style, etc.), and so on.

In one example, the device 12a may receive food characteristic data over the communication channel 16a when the consumer 1 orders food from the food menu 26 (including any modification thereof), retrieves preference data for the consumer 1 from local storage at the device 12a, and locally performs the comparison at the device 12a to determine suitable food for the consumer 1. In another example, the device 14 may receive the preference data over the communication 16a, retrieve the food characteristic data from local storage, and locally perform the comparison to determine suitable food for the consumer 1. In either case, the device 14 may modify the food menu 26 (e.g., delete a food option, gray-out a food option, highlight a restricted food, etc.) based on the comparison to prevent the consumer 1 from completing an order with consumer-specific disfavored food (e.g., when there is a match in the comparison that indicates a restricted food, etc.).

Similarly, a food item may be highlighted and used as a suggestion for favored food to include in the order (e.g., to meet an intake requirement, etc.). Thus, food options may be determined on a user-specific and granular level. For example, food that meets a nutrition requirement (e.g., broccoli) may not meet ingredient preferences and a weight may be applied to determine whether food (alone or in combination with other food ordered) is satisfactory (e.g., favored) and/or unsatisfactory (e.g., disfavored).

Additionally, an alert may be generated when there is an issue with the order to indicate that the order includes a consumer-specific disfavored food. For example, the alert may be generated by the device 12a and forwarded to the device 14, which may notify the employee of the dining establishment that the order includes food that the consumer 1 must not and/or should not eat. The consumer 1 may, however, wish to maintain the preference data a secret. In this case, the alert may be rendered only via the device 12a to the consumer 1. The alert may be presented to the employee of the dining establishment and/or to the consumer 1 visually, tactically, audibly, and so on. Thus, the consumer 1 may be given the opportunity to prevent completing an order with consumer-specific disfavored food. In another example, the alert may indicate that the order includes a consumer-specific favored food, such as when a preference requirement for specific favored content is satisfied and/or recommended.

The consumer 1 may, however, execute an override event for the alert. For example, the alert may be presented directly to the consumer 1 via the device 12a, directly via the device 14 (e.g., a kiosk implementation, etc.), indirectly via the employee of the dining establishment (e.g., that is holding a tablet, wearing smart glasses, etc.), and so on. In response, the consumer 1 may request that the alert be ignored via an option provided by the device 12a and/or the device 14 (e.g., in a kiosk implementation, etc.), via a verbal response issued to the employee of the dining establishment by the consumer 1 to ignore the alert, etc. The override event may be logged in a data repository and used by the dining establishment to limit liability, to provide historical data, and so on.

Additionally, the device 12a may automatically track intake information for the food in the order. For example, the consumer 1 may use the device 12a to automatically track the nutrition information for food in the order that will be consumed by the consumer 1. The device 12a may, for example, communicate with a food tracking application via a tracking application API to exchange the intake information for food in the order. The device 14 may, for example, provide the food characteristic data for the food in the order to the device 12a when the consumer 1 stops ordering, when another consumer begins ordering, before a further gesture, after an override event, and so on. Thus, convenience to the consumer 1 may be maximized, errors caused by manually inputting nutrition information may be minimized, and so on.

One or more aspects of embodiments discussed above may then be repeated for the consumers 2-3. For example, the device 14 may identify another gesture such as another swipe in a direction of the consumer 2 that is to place an order (e.g., continue the food order, etc.) and automatically transmit food characteristic data for food in the order. The device 12b may, for example, receive food characteristic data over the communication 16b when the consumer 2 orders food, may retrieve preference data for the consumer 2 from local storage at the device 12b, and may locally perform a comparison at the device 12b to determine suitable food for the consumer 2. The food menu 26 may be modified based on the comparison to prevent the consumer 2 from ordering food that the consumer 2 must not eat and/or should not eat. In addition, an alert may be generated indicating that the order includes a consumer-specific favored food, disfavored food, and so on. The consumer 2 may execute an override event for the alert, and the device 12b may automatically track intake information for the food in the order that will be consumed by the consumer 2.

The system 10 may further account for when a consumer is to place an order for another consumer, such as when a parent places an order for a child. For example, the device 14 may determine that a device is not found for consumer 4 seated at the table 18. In one example, a gesture may be made that selects the consumer 4 at the table 18, such as swiping the device 14 towards a seat of the table 18, and the gesture 22 may be made to select the consumer 1 as the consumer that will order food on behalf of the consumer 4 (e.g., a proxy order). Any gesture string (e.g., combination of two or more gestures) may be implemented to indicate that a proxy order is to be made. The employee of the establishment may confirm that the consumer 1 is to place the order before making the gesture 22. In another example, the consumer 1 may make a gesture to select the consumer 4 and take ownership of the order for the consumer 4 when an order is to be made at a common ordering area (e.g., a kiosk implementation, etc.). In either case, a proxy gesture may indicate access to preference data is to be driven by the device associated with the proxy consumer.

One or more aspects of embodiments involving the consumers 1-3 may be repeated for the consumer 4. For example, the device 14 may link specific food of the order with the consumer 4. In addition, food characteristic data and/or preference data may be accessed to generate a comparison for the consumer 4. Additionally, an alert may be provided via the devices 12, 14 to indicate that the order includes food that the consumer 4 must not eat and/or should not eat. The alert may be ignored in response to an override event, which may be logged in a data repository. Moreover, food characteristic data for the food to be consumed by the consumer 4 may be tracked via an intake tracking profile. The intake tracking profile may be managed by the consumer 1, may be accessible to the consumer 4 at a later date using a device associated with the consumer 4, and so on.

When the food is ready to be allocated, the device 14 may automatically provide the position of the consumers 1-4 and the specific food in the order for each of the consumers 1-4 to facilitate proper food allocation. For example, the device 14 may indicate that the consumer 1 is in seat 28a of the table 18 and is to receive specific food 29a in the order, that the consumer 2 is in seat 28b of the table 18 and is to receive specific food 29b in the order, that the consumer 3 is in seat 28c of the table 18 and is to receive specific food 29c in the order, and/or that the consumer 4 is in seat 28d of the table 18 and is to receive specific food 29d in the order. In one example where individuals may have moved before food is allocated, the device 14 may repeat position determination techniques and/or receive an indication of the move to confirm allocations.

Moreover, in a full-service implementation for example, an employee of the dining establishment that takes an order may not be the same employee that delivers the food of the order. In this regard, the device 14 may include a subset of functionality discussed above. In one example, the device 14 used to allocate food may only have display capabilities to display that the consumers 1-4 are in respective seats 29a-29d and are to receive respective specific food 29a-29d. In another example, the device 14 used to allocate food may only display that a subset of the consumer 1-4 in respective seats 29a-29d are to receive respective food 29a-29d. Accordingly, many employees of the dining establishment may use respective devices 14 to allocate food on a priority basis, on an order-completion basis, on a first-in-first-out basis, and so on.

Thus, efficiency and convenience may be maximized since no user-to-user interaction is needed during food allocation to determine which food of the order belongs to which consumer. Similarly, efficiency and convenience may be maximized when link data is used to announce that specific food of an order is ready for pick-up by a specific consumer (and/or authorized individual). For example, consumer 1 may be prompted to pick up the specific food 29a-29b when consumer 1 has ordered the specific food 29a-29b during a proxy order.

While examples provide various features of the system 10 for illustration purposes, it should be understood that one or more features of the system 10 may reside in the same and/or different physical and/or virtual locations, may be combined, omitted, bypassed, re-arranged, and/or be utilized in any order. Moreover, any or all features of the system 10 may be automatically implemented (e.g., without human intervention, etc.).

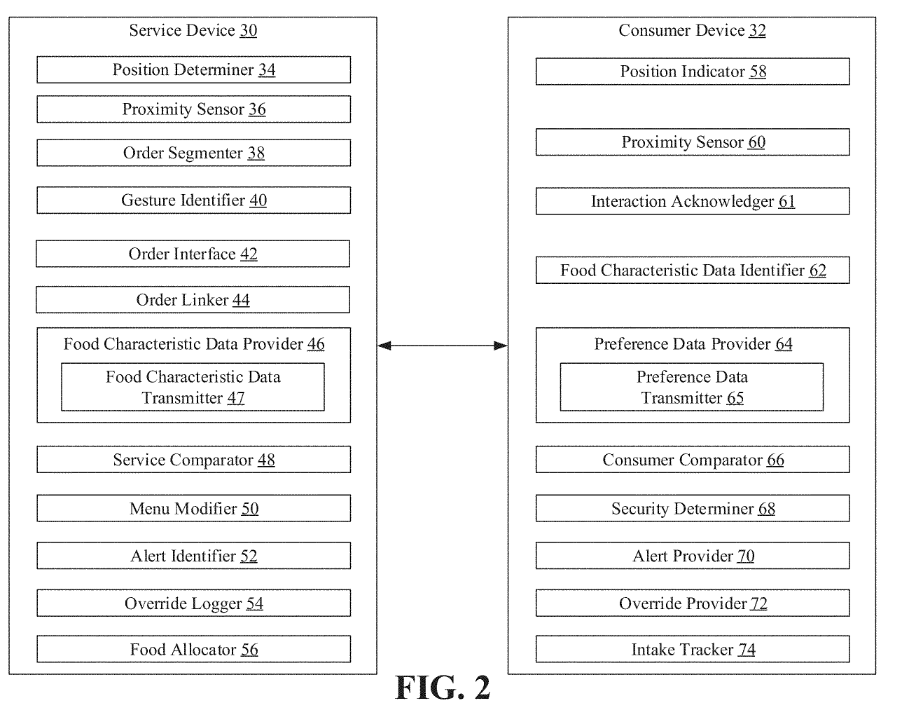

FIG. 2 shows a service device 30 and a consumer device 32 according to an embodiment. The devices 30, 32 may have logic (e.g., logic instructions, configurable logic, fixed-functionality logic hardware, etc.) configured to implement any of the herein mentioned technologies including, for example, tracking food intake, determination of suitable food for a consumer, proper allocation of food, alert processing, override event processing, and so on. Thus, the service device 30 may include the same functionality as the device 14 of the system 10 (FIG. 1A-1B), discussed above, and/or the consumer device 32 may include the same functionality as the device 12 of the system 10 (FIG. 1A), discussed above.

In the illustrated example, the service device 30 includes a position determiner 34 to determine a position of a consumer that is to place an order for food (e.g., from a food menu). The position determiner 34 may, for example, determine the position of the consumer via a device associated with the consumer, such as the consumer device 32. For example, the position determiner 34 may determine the position of the consumer using proximity data received at a proximity sensor 36 of the service device 30. The position determiner 34 may, for example, determine that the consumer is located at a specific seat of a specific table of a dining establishment.

The service device 30 further includes an order segmenter 38 to segment an order. For example, the service device 30 may include a hand-held mobile computing platform that approaches a table at the dining establishment and uses sensor data (e.g., accelerometer data, magnetometer data, compass, etc.) to determine that an order is to be initiated based on movement of the service device 30 that falls below a predetermined threshold value. The segmenter 38 may, for example, initiate the order when the threshold is satisfied. The order segmenter 38 may further utilize sensor data to determine that an order is to be terminated and/or suspended based on movement of the service device 30 that rises above a predetermined threshold value, and segment the order when the threshold is satisfied.

The service device 30 further includes a gesture identifier 40 to identify a gesture that may be used to segment the order. The gesture identifier 40 may, for example, identify a point gesture, identify a touch gesture, identify a verbal gesture, etc., involving an icon displayed by the service device 30 that is used by order segmenter 38 to initiate the order. For example, the order segmenter 38 may use touch data from a touch gesture to cause an order interface 42 to render a food menu, to input the order, to suspend the order, to terminate the order, and so on. In another example where the service device 30 includes AR glasses that are used to place the order, a voice recognizer may recognize voice inputs (e.g., voice of a waiter/waitress, etc.) to input the order (e.g., by repeating back what the consumer said).

The gesture identifier 40 may also identify a gesture to select a consumer that is to place an order. The gesture identifier 40 may, for example, identify a verbal gesture (e.g., an AR implementation, etc.), a swipe gesture (e.g., a hand-held implementation, etc.), etc., by an employee of the dining establishment to select a consumer using the service device 30. The gesture identifier 40 may also identify a further gesture to select a further consumer associated with the consumer that is to place the order on behalf of the further consumer (e.g., a proxy order). For example, the gesture identifier 40 may identify a touch gesture to select a seat position corresponding the further consumer (e.g., a child, etc.) and a swipe gesture to select the consumer (e.g., a parent, etc.) that is to place the order on behalf of the further consumer. In another example, the gesture identifier 40 may identity a point gesture when the service device 30 is pointed in a direction of the further consumer (e.g., via sensor data, etc.) to select the consumer and an audio gesture that is input via voice recognition to select the proxy consumer.

The service device 30 further includes an order linker 44 to link specific food of an order with a consumer that is to be selected (e.g., based on an gesture). The order linker 44 may, for example, link a food input via the order interface 42 with a consumer that is presently selected (e.g., that is ordering food). Similarly, the order linker 44 may link a food input via the order interface 42 with a further consumer whose order is made on their behalf. Thus, link data generated by the order linker 44 associating a consumer with food in an order may be stored as a data structure (e.g., table, etc.) having fields for a consumer, for food ordered by a consumer, for a position of a consumer in a dining establishment (e.g., a seat position, etc.), for a class of consumer (e.g., a proxy consumer, a further consumer, etc.), for an identification of a consumer (e.g., numerical ID for a consumer, etc.), and so on.

Notably, the food ordered by a consumer may include ingredients that a consumer must not and/or should not eat. Accordingly, the service device 30 includes a food characteristic data provider 46 to provide food characteristic data for food in a food menu, for food that is actually ordered by a consumer, and so on. For example, the food characteristic data provider 46 may include a food characteristic data transmitter 47 to provide food characteristic data to a service comparator 48 to generate a comparison between the food characteristic data and food preference data when the service device 30 is authorized to access the food preference data. Thus, the service device 30 includes a menu modifier 50 to modify the food menu based on the comparison, such as by deleting food as an option from the food menu, etc. The food characteristic data transmitter 46 may also transmit the food characteristic data to a remote comparator (e.g., to a consumer device, a cloud-computing device, etc.) to generate the comparison between the food characteristic data and food preference data. In this regard, the menu modifier 50 may modify the food menu based on the comparison implemented remotely.

The service device 30 further includes an alert identifier 52 to identify an alert that indicates an order includes a consumer-specific disfavored food, favored food, and so on. Accordingly, a consumer may be afforded an opportunity to place an order that excludes and/or includes food. For example, the alert may be rendered remotely to a device associated with the consumer, such as the consumer device 32, to notify the consumer of consumer-specific disfavored food. Similarly, the alert may be rendered locally by the service device 30 to notify the consumer of the consumer-specific disfavored food (e.g., a kiosk implementation), to notify the employee of the dining establishment of the consumer-specific disfavored food, and so on.

Additionally, the service device 30 includes an override logger 54 to identify an override event for an alert by a consumer and to log the override event in a data repository. The consumer may, for example, instruct an employee of the establishment to ignore an alert that is rendered by the service device 30 and that is communicated by the employee. In this regard, the employee may relay the command from the consumer to ignore the alert and the corresponding override event may be logged by the override logger 54 in a data repository to document the override event. The override logger 54 may, for example, log further details regarding the issue, the alert, and/or an override event when the consumer allows access to personal information. Thus, the data repository may be used to determine liability for damage caused by the command, may limit liability of the dining establishment when the command is properly followed, etc.

The service device 30 further includes a food allocator 56 to associate a consumer with a specific food for proper allocation of the specific food to the consumer. The food allocator 56 may, for example, access link data to determine a seat position of a consumer and a specific food for the consumer. Moreover, the food allocator 56 may access link data to determine a seat position of a further consumer with specific food for that further consumer. The food allocator 56 may also access link data to determine that specific food is ready for pick-up by a consumer (e.g., in a kiosk implementation, etc.).

The illustrated consumer device 32 includes a position indicator 58 to indicate the position of a consumer, such as a location of the consumer in the dining establishment. The position indicator 56 may, for example, provide proximity data from a proximity sensor 60 to the proximity sensor 36 of the service device 30. In addition, the consumer device 32 includes an interaction acknowledger 61 that acknowledges an interaction is to start with an ordering device, such as the service device 30. In this regard, the service device 30 may include a corresponding component to request an interaction (e.g., an interaction requester).

Notably, food ordered by a consumer may include ingredients that a consumer must not and/or should not eat. Accordingly, the consumer device 32 includes a food characteristic data identifier 62 to access food characteristic data for food in a food menu, for food that is actually ordered by a consumer, and so on. For example, the food characteristic data identifier 60 may identify food characteristic data provided by the food characteristic data provider 46. The consumer device 32 further includes a preference data provider 64 to provide preference data. For example, the preference data provider 64 includes a preference data transmitter 65 to transmit a list of food preferences to a consumer comparator 66 to generate a comparison between the food characteristic data and the list of food preferences. The preference data transmitter 65 may also transmit preference data to a remote comparator, such as the service comparator 48. In this regard, the service device 30 may include a corresponding component to identify preference data (e.g., a preference data identifier, etc.).

The consumer device 32 further includes a security determiner 68 to determine whether a device, such the service device 30, is to access a list of food preferences. The security determiner 68 may, for example, permit and/or deny access to a list of food preferences based on user-specified preferences (e.g., on a per-establishment basis, on a classification basis, etc.), based on one-time usage restrictions (e.g., based on a time-to-live, etc.), based on security risk (e.g., opening a secure communication channel, analysis of a security breach, etc.), etc. The security determiner 68 may control access based control by the consumer to opt-in or opt-out on a granular level (case-by-case basis), on a global level (types of establishments, etc.), and so on.

The consumer device 32 further includes an alert provider 70 to provide an alert that indicates an order includes a consumer-specific disfavored food, a consumer-specific favored food, and so on. Accordingly, the consumer may be afforded the opportunity to place an order that excludes consumer-specific disfavored food, that includes consumer-specific favored food, and so on. For example, the alert may be rendered remotely to a device associated with the dining establishment, such as the service device 30, to notify an employee of the dining establishment of the consumer-specific disfavored food. Similarly, the alert may be rendered locally by the consumer device 32 to directly notify a consumer of the consumer-specific disfavored food. In one example, the consumer may not wish to share any personal information with the dining establishment and permit the alert to reach the consumer via the consumer device 32 and not the dining establishment. In another example, the consumer may allow an employee of the dining establishment to receive an alert via the service device without details to allow the consumer to correct the order without indicating specific preferences.

The consumer device 32 further includes an override provider 72 to provide an override event for an alert, such as an alert that indicates an order includes a consumer-specific disfavored food. For example, the override provider 72 may automatically provide an override event based on user-specified preferences (e.g., on a per-establishment basis, on a classification basis, etc.), based on one-time override restrictions (e.g., based on a command from a consumer via a user interface, etc.), based on risk (e.g., analysis of an allergy risk, etc.), and so on. In one example, the consumer associated with the consumer device 32 may utilize a user interface to provide a command to ignore an alert, which may be automatically transmitted and/or logged as an override event.

The consumer device 32 further includes an intake tracker 74 to automatically track intake information for food in an order. The intake tracker 74 may, for example, communicate with a food tracking application via a tracking application API to exchange nutrition information for food in an order. In one example, nutrition information that is exchanged corresponds to food that is expected to be consumed by a specific consumer. The intake tracker 74 may, for example, provide food characteristic data for food in an order when a consumer has stopped ordering, when another consumer has begun ordering, after an override event, and so on.

The consumer device 32 may further account for when a consumer associated with the consumer device 32 is to place an order for another consumer, such as when a parent places an order for a child. The consumer device 32 may, for example, receive an indication from the service device 30 that a consumer associated with the consumer device 32 has been selected (e.g. via a gesture, etc.) to order on behalf of a further consumer (e.g., as a proxy consumer). The consumer device 32 may also receive input from the consumer that indicates a consumer associated with the consumer device 32 is to order on behalf of a further consumer. In addition, the consumer device 32 may automatically notify the service device 30 that a consumer associated with the consumer device 32 has taken responsibility for the order corresponding to a further consumer.

In this regard, the intake tracker 74 may identify a profile associated with the further consumer and automatically track intake information for food in an order corresponding to the further consumer. For example, the intake tracker 74 may track nutrition information for a further consumer when the service device 30 and/or when the consumer device 32 is authorized to access a list of food preferences for the further consumer, and/or when the intake tracker 74 is authorized to communicate with a food tracking application via a tracking application API to exchange intake information for food in the order corresponding to the further consumer.

While examples provide various components of the devices 30, 32 for illustration purposes, it should be understood that one or more components of the devices 30, 32 may reside in the same and/or different physical and/or virtual locations, may be combined, omitted, bypassed, re-arranged, and/or be utilized in any order. Moreover, any or all components of the devices 30, 32 may be automatically implemented (e.g., without human intervention, etc.).

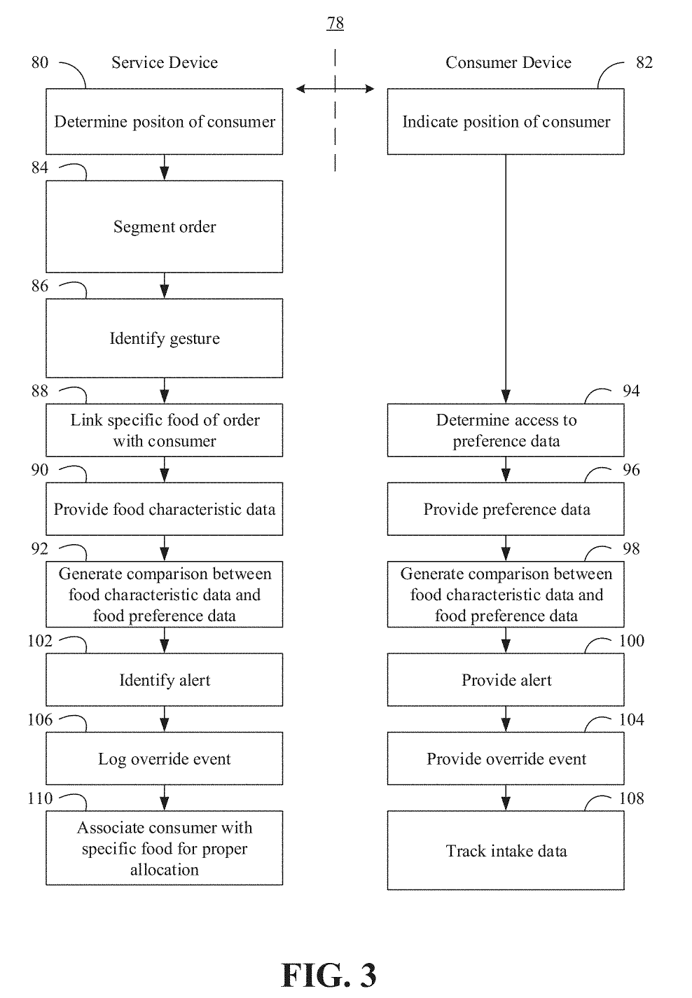

Turning now to FIG. 3, a method 78 is shown to process a food order that includes suitable food for a consumer according to an embodiment. The method 78 may be implemented via a system, such as the system 10 (FIG. 1), discussed above, via devices, such as one or more of the devices 30, 32 (FIG. 2), discussed above, and so on. The method 78 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 78 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 80 provides for determining a position of a consumer at a dining establishment that is to place an order for food (e.g., from a food menu). Block 80 may, for example, determine the position of the consumer via a device associated with the consumer. For example, block 80 may determine the position of the consumer using proximity data from a proximity sensor of the device associated with the consumer. Illustrated processing block 82 indicates the position of the consumer. Block 82 may, for example, provide the proximity data from a proximity sensor to block 80. Thus, blocks 80, 82 may communicate to triangulate the position of the consumer.

Illustrated processing block 84 provides for segmenting an order. Block 84 may segment an order based on, for example, a gesture to initiate an order, to suspend an order, to terminate an order, and so on. Block 84 may also segment an order using, for example, sensor data such as accelerometer data to determine order segments based on movement relative to a predetermined threshold value. Illustrated processing block 86 provides for identifying a gesture to select a consumer that is to place an order. Block 86 may, for example, identify a verbal gesture to select a consumer, a swipe gesture to select a consumer, etc. Block 86 may also identify a further gesture to select a further consumer associated with a consumer that is to place an order on behalf of the further consumer.

Illustrated processing block 88 provides for linking specific food of an order with a consumer that is to be selected (e.g., based on one or more gestures, etc.). Block 88 may, for example, link a food input (e.g., using a food menu) with a consumer that is presently selected (e.g., that is ordering food). Similarly, Block 88 may link a food input with a further consumer whose order is made on their behalf via a proxy consumer. Thus, Block 88 may associate a consumer with food in an order and store the link data as a data structure (e.g., table, etc.) having fields for a consumer, for food ordered by a consumer, for a position of a consumer in a dining establishment, for a class of consumer, for an identification of a consumer, and so on.

Illustrated processing block 90 provides food characteristic data for food in a food menu, for food that is actually ordered by a consumer, and so on. For example, block 90 may provide food characteristic data to illustrated processing block 92, which provides for generating a comparison between the food characteristic data and food preference data. In this regard, illustrated processing block 94 provides for determining whether a device is to access the preference data, such as whether block 92 is to access a list of food preferences. If so, illustrated processing block 96 provides the food preference data to block 92. Similarly, block 94 may determine whether illustrated processing block 98 is to access the food preference data. If so, block 96 provides the food preference data to block 98. In addition, block 98 accesses the food characteristic data from block 90 (e.g., if authorized to access the food characteristic data) to generate the comparison between the food characteristic data and the food preference data.

Illustrated processing block 100 provides an alert, for example to indicate an order includes a consumer-specific disfavored food, includes a consumer-specific favored food, and so on. For example, block 100 may provide a visual alert to be rendered via a graphical user interface, an auditory alert to be rendered via an auditory user interface, a tactile alert to be rendered via a tactile user interface, and so on. The alert may be rendered locally to a consumer and/or may be rendered via a remote computing platform to be relayed to the consumer. For example, block 100 may provide the alert based on the comparison (e.g., match, etc.) to illustrated processing block 102, which provides for identifying the alert. Accordingly, a consumer may be afforded an opportunity to place an order that excludes consumer-specific restricted food, etc.

Illustrated processing block 104 provides an override event for an alert, such as an alert issued to indicate the order includes a consumer-specific restricted food. Block 104 may, for example, provide a visual override event to be input via a graphical user interface, an auditory override event to be input via an auditory user interface, a tactile override event to be issued via a tactile user interface, and so on. Block 104 may provide an override event to illustrated processing block 106, which logs the event. Block 106 may also, however, identify and log an override event independently of block 104 (e.g., a local override event). Thus, an alert may be rendered locally and/or remotely using one or more devices associated with a consumer, a dining establishment, and so on.

Illustrated processing block 108 provides for tracking intake information for food in an order. Block 108 may, for example, communicate with a food tracking application via a tracking application API to exchange nutrition information for food in an order. In one example, intake information that is exchanged corresponds to food expected to be consumed by a specific consumer. Block 108 may, for example, provide food characteristic data for food in an order when a consumer has stopped ordering, when another consumer has begun ordering, before a further gesture, after an override event, etc.

Block 108 may further account for when a consumer is to place an order for another consumer, such as when a parent places an order for a child. Block 108 may, for example, receive an indication from that a consumer has been selected (e.g. via a gesture, etc.) and is to order on behalf of a further consumer. Block 108 may also receive input from the consumer that indicates a consumer is to order on behalf of a further consumer. In addition, block 108 may identify a profile associated with the further consumer and track intake information for food in an order corresponding to the further consumer.

Illustrated processing block 110 provides for associating a consumer with a specific food for proper allocation of the specific food to the consumer. Block 110 may, for example, access link data to determine a seat position of a consumer and a specific food for the consumer. Moreover, block 110 may access link data to determine a seat position of a further consumer with specific food for that further consumer. Block 110 may also access link data to determine that specific food is ready for pick-up by a consumer (e.g., in a kiosk implementation, etc.).

While independent blocks and/or a particular order has been shown for illustration purposes, it should be understood that one or more of the blocks of the method 78 may be combined, omitted, bypassed, re-arranged, and/or flow in any order. Moreover, any or all blocks of the method 78 may be automatically implemented (e.g., without human intervention, etc.).

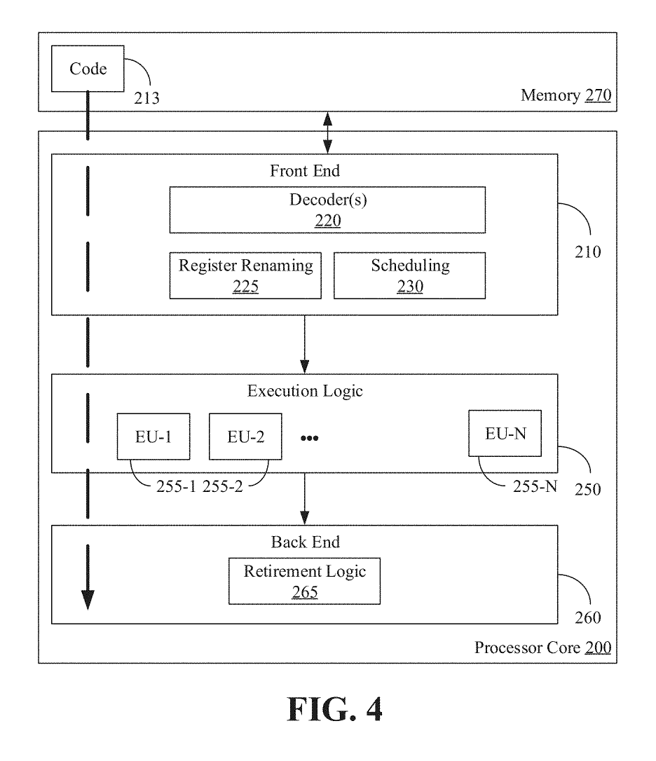

FIG. 4 shows a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 4, a processing element may alternatively include more than one of the processor core 200 illustrated in FIG. 4. The processor core 200 may be a single-threaded core or, for at least one embodiment, the processor core 200 may be multithreaded in that it may include more than one hardware thread context (or “logical processor”) per core.

FIG. 4 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the system 10 (FIGS. 1A-1B), the devices 30, 32 (FIG. 2), and/or the method 78 (FIG. 3), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 4, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

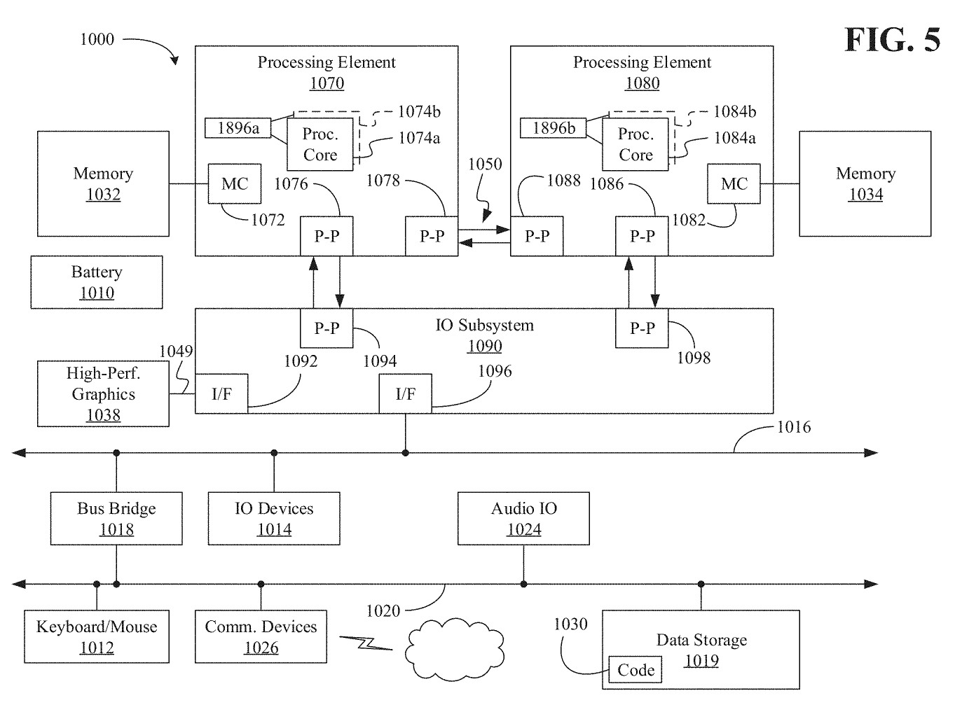

Referring now to FIG. 5, shown is a block diagram of a computing system 1000 embodiment in accordance with an embodiment. Shown in FIG. 5 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 5 may be implemented as a multi-drop bus rather than point-to-point interconnect.

As shown in FIG. 5, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 4.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 5, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 5, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 5, various I/O devices 1014 (e.g., cameras, sensors, etc.) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026 (which may in turn be in communication with a computer network), and a data storage unit 1019 such as a disk drive or other mass storage device which may include code 1030, in one embodiment. The illustrated code 1030 may implement the system 10 (FIGS. 1A-1B), the devices 30, 32 (FIG. 2), and/or the method 78 (FIG. 3), already discussed. Further, an audio I/O 1024 may be coupled to second bus 1020 and a battery 1010 may supply power to the computing system 1000.

Note that other embodiments are contemplated. For example, instead of the point-to-point architecture of FIG. 5, a system may implement a multi-drop bus or another such communication topology. Also, the elements of FIG. 5 may alternatively be partitioned using more or fewer integrated chips than shown in FIG. 5.

### ADDITIONAL NOTES AND EXAMPLES

Example 1 may include a system to process a food order that includes suitable food for a consumer comprising a service apparatus including, a position determiner, implemented at least partly in one or more of configurable logic or fixed functionality logic hardware, to determine a position of a consumer at a dining establishment via proximity data from a sensor of a personal device associated with the consumer, wherein the consumer is to place an order for food from a food menu, a food characteristic data provider, implemented at least partly in one or more of configurable logic or fixed functionality logic hardware, to provide food characteristic data for the food, and an order interface to render the food menu and/or input the order, and a consumer apparatus including, a position indicator, implemented at least partly in one or more of configurable logic or fixed functionality logic hardware, to indicate the position of the consumer, a food characteristic data identifier, implemented at least partly in one or more of configurable logic or fixed functionality logic hardware, to identify the food characteristic data for the food, and a comparator, implemented at least partly in one or more of configurable logic or fixed functionality logic hardware, to generate a comparison between the food characteristic data and food preference data to determine suitable food in the order for the consumer.

Example 2 may include an apparatus to process a food order comprising a position determiner, implemented at least partly in one or more of configurable logic or fixed functionality logic hardware, to determine a position of a consumer at a dining establishment via proximity data from a sensor of a personal device associated with the consumer, wherein the consumer is to place an order for food from a food menu, a food characteristic data provider, implemented at least partly in one or more of configurable logic or fixed functionality logic hardware, to provide food characteristic data for the food, and an order interface to render the food menu and/or input the order.

Example 3 may include the apparatus of Example 2, wherein the apparatus is to include one or more of, a mobile computing platform that is moveable between two or more dining areas of the dining establishment, wherein the mobile computing platform is to include one or more of a hand-held mobile computing platform, a wearable mobile computing platform, or an actuator to implement a movement by the mobile computing platform, or a fixed computing platform that is to be located at a fixed location of the dining establishment, wherein the fixed location is to include one or more of a common ordering area or a dining area.

Example 4 may include the apparatus of any one of Examples 2 to 3, further including an order segmenter to segment the order.

Example 5 may include the apparatus of any one of Examples 1 to 4, further including, a service comparator to generate a comparison between the food characteristic data and food preference data, and a menu modifier to modify the food menu based on the comparison.

Example 6 may include the apparatus of any one of Examples 1 to 5, further including, an alert identifier to identify an alert that indicates the order includes a consumer-specific disfavored food, and an override logger to, identify an override event for the alert by the consumer, and log the override event in a data repository.

Example 7 may include the apparatus of any one of Examples 1 to 6, further including a food allocator to associate the consumer with specific food of the order for proper allocation of the specific food to the consumer.

Example 8 may include the apparatus of any one of Examples 1 to 7, further including, a gesture identifier identify a gesture to select the consumer, and an order linker to link specific food of the order with the consumer.

Example 9 may include the apparatus of any one of Examples 1 to 8, wherein the gesture identifier is to identify a further gesture to select a further consumer associated with the consumer that is to place the order on behalf of the second consumer, and wherein the order linker is to link further specific food of the order with the further consumer.

Example 10 may include an apparatus to determine suitable food for a consumer comprising a position indicator, implemented at least partly in one or more of configurable logic or fixed functionality logic hardware, to indicate a position of a consumer at a dining establishment via proximity data from a sensor of a personal device associated with the consumer, wherein the consumer is to place an order for food from a food menu, a food characteristic data identifier, implemented at least partly in one or more of configurable logic or fixed functionality logic hardware, to identify food characteristic data for the food, and a consumer comparator, implemented at least partly in one or more of configurable logic or fixed functionality logic hardware, to generate a comparison between the food characteristic data and food preference data to determine suitable food in the order for the consumer.

Example 11 may include the apparatus of Example 10, further including a security determiner to determine whether a device associated with the dining establishment is to access the food preference data.

Example 12 may include the apparatus of any one of Examples 10 to 11, further including an alert provider to provide an alert to indicate the order includes a consumer-specific disfavored food.

Example 13 may include the apparatus of any one of Examples 10 to 12, further including an override provider to provide an override event for an alert issued to indicate the order includes a consumer-specific disfavored food.

Example 14 may include the apparatus of any one of Examples 10 to 13, further including an intake tracker to track intake information for the food in the order.

Example 15 may include at least one computer readable storage medium comprising a set of instructions, which when executed by a processor, cause the processor to determine a position of a consumer at a dining establishment via proximity data from a sensor of a personal device associated with the consumer, wherein the consumer is to place an order for food from a food menu, provide food characteristic data for the food, and render the food menu and/or input the order.

Example 16 may include the at least one computer readable storage medium of Example 15, wherein the instructions, when executed, cause the processor to implement one or more of a mobile computing platform that is moveable between two or more dining areas of the dining establishment, wherein the mobile computing platform is to include one or more of a hand-held mobile computing platform, a wearable mobile computing platform, or an actuator to implement a movement by the mobile computing platform, or a fixed computing platform that is to be located at a fixed location of the dining establishment, wherein the fixed location is to include one or more of a common ordering area or a dining area.

Example 17 may include the at least one computer readable storage medium of any one of Examples 15 to 16, wherein the instructions, when executed, cause the processor to segment the order.

Example 18 may include the at least one computer readable storage medium of any one of Examples 15 to 17, wherein the instructions, when executed, cause the processor to generate a comparison between the food characteristic data and food preference data, and modify the food menu based on the comparison.

Example 19 may include the at least one computer readable storage medium of any one of Examples 15 to 18, wherein the instructions, when executed, cause the processor to identify an alert that indicates the order includes a consumer-specific disfavored food, identify an override event for the alert by the consumer, and log the override event in a data repository.

Example 20 may include the at least one computer readable storage medium of any one of Examples 15 to 19, wherein the instructions, when executed, cause the processor to associate the consumer with specific food of the order for proper allocation of the specific food to the consumer.

Example 21 may include the at least one computer readable storage medium of any one of Examples 15 to 20, wherein the instructions, when executed, cause the processor to identify a gesture to select the consumer, and link specific food of the order with the consumer.

Example 22 may include the at least one computer readable storage medium of any one of Examples 15 to 21, wherein the instructions, when executed, cause the processor to identify a further gesture to select a further consumer associated with the consumer that is to place the order on behalf of the second consumer, and link further specific food of the order with the further consumer.

Example 23 may include a method to process a food order comprising determining a position of a consumer at a dining establishment via proximity data from a sensor of a personal device associated with the consumer, wherein the consumer places an order for food from a food menu, providing food characteristic data for the food, and rendering the food menu and/or inputting the order.

Example 24 may include the method of Example 23, further including implementing one or more of a mobile computing platform that is moveable between two or more dining areas of the dining establishment, wherein the mobile computing platform is to include one or more of a hand-held mobile computing platform, a wearable mobile computing platform, or an actuator to implement a movement by the mobile computing platform, or a fixed computing platform that is to be located at a fixed location of the dining establishment, wherein the fixed location is to include one or more of a common ordering area or a dining area.

Example 25 may include the method of any one of Examples 23 to 24, further including segmenting the order.

Example 26 may include the method of any one of Examples 23 to 25, further including generating a comparison between the food characteristic data and food preference data, and modifying the food menu based on the comparison.

Example 27 may include the method of any one of Examples 23 to 26, further including identifying an alert that indicates the order includes a consumer-specific disfavored food, identifying an override event for the alert by the consumer, and logging the override event in a data repository.

Example 28 may include the method of any one of Examples 23 to 27, further including associating the consumer with specific food of the order for proper allocation of the specific food to the consumer.

Example 29 may include the method of any one of Examples 23 to 28, further including identifying a gesture to select the consumer, and linking specific food of the order with the consumer.

Example 30 may include the method of any one of Examples 23 to 29, further including identifying a further gesture to select a further consumer associated with the consumer that is to place the order on behalf of the second consumer, and linking further specific food of the order with the further consumer.

Example 31 may include an apparatus to process a food order comprising means for performing the method of any one of Examples 23 to 30.

Example 32 may include at least one computer readable storage medium comprising a set of instructions, which when executed by a processor, cause the processor to indicate a position of a consumer at a dining establishment via proximity data from a sensor of a personal device associated with the consumer, wherein the consumer is to place an order for food from a food menu, identify food characteristic data for the food, and generate a comparison between the food characteristic data and food preference data to determine suitable food in the order for the consumer.

Example 33 may include the at least one computer readable storage medium of Example 32, wherein the instructions, when executed, cause the processor to determine whether a device associated with the dining establishment is to access the food preference data.

Example 34 may include the at least one computer readable storage medium of any one of Examples 32 to 33, wherein the instructions, when executed, cause the processor to provide an alert to indicate the order includes a consumer-specific disfavored food.

Example 35 may include the at least one computer readable storage medium of any one of Examples 32 to 34, wherein the instructions, when executed, cause the processor to provide an override event for an alert issued to indicate the order includes a consumer-specific disfavored food.

Example 36 may include the at least one computer readable storage medium of any one of Examples 32 to 35, wherein the instructions, when executed, cause the processor to track intake information for the food in the order.

Example 37 may include a method to determine suitable food for a consumer comprising indicating a position of a consumer at a dining establishment via proximity data from a sensor of a personal device associated with the consumer, wherein the consumer places an order for food from a food menu, identifying food characteristic data for the food, and generating a comparison between the food characteristic data and food preference data to determine suitable food in the order for the consumer.

Example 38 may include the method of Example 37, further including determining whether a device associated with the dining establishment is to access the food preference data.

Example 39 may include the method of any one of Examples 37 to 38, further including providing an alert to indicate the order includes a consumer-specific disfavored food.

Example 40 may include the method of any one of Examples 37 to 39, further including providing an override event for an alert issued to indicate the order includes a consumer-specific disfavored food.

Example 41 may include the method of any one of Examples 37 to 40, further including tracking intake information for the food in the order.

Example 42 may include an apparatus to process a food order comprising means for performing the method of any one of Examples 37 to 41.

Thus, techniques described herein provide for seamless distribution of nutritional information from, e.g., a restaurant. In addition, embodiments provide for verification that a consumer's preferences are satisfied. Moreover, embodiments provide for distribution of a correct meal (e.g., dish, etc.) to a correct consumer. Embodiments may minimize a direct interaction by a consumer and an employee of the restaurant. Thus, embodiments may track what was eaten, may provide an understanding regarding what is about to be eaten, and to make determinations in an environment where multiple individuals are ordering together. Embodiments may also distinguish who ordered what food to confirm that preferences are met of specific consumers (e.g., patrons).

Embodiments may include, for example, utilization of an ordering device (e.g., tablet, AR/VR smart device such as eyeglasses, etc.) that may be used by a waiter/waitress in a full-service sit-down restaurant. The ordering device may include a smart ordering kiosk such as a smart cash register and/or a point-of-sale terminal. In one example, the kiosk may be located at a non-full service sit-down restaurant. In addition, the ordering device may interact with a device belonging to a consumer, such as a smart phone, smart watch, AR/VR glasses, and so on. In one example, the restaurant may transmit nutrition information (e.g., ingredients) that may be checked by the consumer (e.g., via respective devices, etc.). The consumer may use the nutrition information to automatically populate existing nutrition tracking applications. In addition, a list of ingredients may be used to check for foods that the consumer is not permitted to eat, that are on a consumer “do not detest list”, and so on.

Moreover, for example where a food menu is directly shown to a consumer (e.g., a table-mounted kiosk, etc.), a consumer may choose to have their personal device share their preferences and the kiosk may “grey out” or not display items that contradict the preferences. In a further embodiment, such as in a full-service restaurant, a location determination technique may be implemented wherein the ordering device determines the relative location of a consumer ordering each item. Notably, the determination technique may be implemented when one consumer orders food for multiple consumers.

Embodiments may also provide a notification when an issue is detected (e.g., a customer tried to order a food that is on a prohibited list). A notification may be sent to the ordering device (e.g., to a waiter/waitress, a point-of-sales kiosk, etc.) that facilitates correction of an order. In addition, the restaurant may log an event when the consumer overrides the notification that may useful to limit liability. Additionally, the notification is kept local to a consumer's device when, for example, the consumer wishes not to share any private details (e.g., food they cannot eat, etc.) with the restaurant.

In one particular embodiment, a waiter/waitress may approach a table of the restaurant and a waitress/waiter application (WAPP) running on a hand-held device determines a relative position of consumer devices running a restaurant experience application (MREA). Triangulation techniques may be implemented to determine relative position. For example, triangulation techniques may be implemented to determine the relative location and distance of the three devices. In one example, x,y Cartesian coordinates may be determined for each of the three devices (although z may also be determined if desired).

An initiation process may include starting an order for the table (e.g., select a “start order” icon, etc.) via the WAPP and/or the MREA. When the consumer orders a dish, the waiter/waitress may enter it into the WAPP by using a gesture on the screen of the hand-held device to point to the consumer that ordered the food. For example, the waiter/waitress may swipe in a direction of the consumer that is to order, that is presently ordering, and/or that just ordered. In another example, the waiter/waitress may point the ordering device (e.g., front of a tablet, front of AR/VR glasses, etc.) in the direction of a consumer and/or swipe in that direction. For example, a waiter/waitress generally is to look at a consumer that is to place an order, and pointing the ordering device towards the consumer may guarantee a widest spread of antenna coverage from antennas of the ordering device (e.g., point based on antenna placement of the ordering device). Thus, trigonometry based on a swipe gesture may select a consumer independent of position of the ordering device (e.g., always point a tablet in one direction in a room, etc.), compass coordinates based on pointing the ordering device may select a consumer independent of a touch gesture, etc.

The WAPP may transmit the nutrition information to the MREA, which automatically populates a nutrition tracking application with the details provided by the WAPP. In one example, an API may be defined to export the nutrition/quantity information in a format comparable with the nutrition tracking application. The MREA may also check to determine whether any ingredients in the ordered food are on a prohibited and/or non-preferred list. Food characteristic data and/or preference data may be stored locally, may be cloud-based, may be locally stored with backup to a cloud, and so on.

If there is an issue with the order, an alert may be sent to the consumer via the consumer device (e.g., vibration, tone, message, etc.). In addition, an alert may be sent via the ordering device. In this regard, the consumer may determine a level of privacy for personal information. The consumer may not wish to share any personal information with the restaurant and permit an alert to reach only the consumer via the consumer device and not the restaurant. In another example, the consumer may allow the waiter/waitress to receive an alert without specific details regarding the alert to allow the consumer to correct the order without indicating specific preferences.

If a parent is ordering for a child, for example, the MRAE may have access to the parent's list and the child's list of foods to avoid. The MRAE may also distinguish foods consumed by the parent and the child. In addition, such as when a gesture is made to indicate a location of a consumer, it may be possible that the consumer is not detected (e.g., no MRAE running on a device, no device for a consumer, etc.). The employee may receive an indication that no device is found, and the employee may ask if one of the parents would like to have their MRAE act for that consumer.

For example, the waiter/waitress may implement a further gesture (e.g., further swipe) when the parent has taken responsibility to order for the child (e.g., a swipe to select the child after a swipe to select the parent, a swipe to select the parent after a swipe to select the child, etc.), and proxy information for the food order is utilized (e.g., a secondary set of foods, etc.) in response to a gesture string (e.g., combination of gestures, etc.). In one example, a “V” shaped gesture that starts at the parent, goes to the child, and then ends back at the parent indicates that the preference data is to be driven by the device associated with the parent. In addition, the parent may indicate that no data is available for a further consumer (e.g., a friend of the child). In another example, an audio keyword gesture input (e.g., “I see you are ordering for your child”) may operate as a gesture to input the order. Location, however, may nonetheless be determined for the further consumer for proper allocation of food independent of preference checks. Thus, a gesture-based system may allow an order to be taken in any sequence (e.g., random, etc.).

Moreover, a kiosk (e.g., via an application, etc.) and an MREA may perform similar interactions for fast-food restaurants and/or other location where food is ordered at a kiosk. For example, the kiosk (e.g., point-of-sale terminal) may not perform precise location determination and/or may find a device directly in front of it. In one example, a relatively simple triangulation may be used to determine what consumer is in front of the kiosk (e.g., antennas on either side of a kiosk to easily determine if there is a wireless device in front of them, etc.). To disambiguate multiple consumers in front of a kiosk, the kiosk may ask the consumers in front of the kiosk to assist in disambiguation (e.g., if within a pre-determined threshold distance).

In addition, the MRAE may show an indication to the consumer that they are to interact. Moreover, gestures may be identified, data exchanged, etc. For example, there may be a confirmation to interact, an order may be entered via the kiosk, nutrition information and/or preference data may be shared, a comparison may be made, alerts may be issued, menus may be modified, and so on, as discussed above.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so on” or “etc.” may mean any combination of the listed terms as well any combination with other terms.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus comprising:
a position determiner, implemented at least partly in one or more of configurable logic or fixed functionality logic hardware, to determine a position of a consumer at a dining establishment via proximity data from a sensor of a personal device associated with the consumer, wherein the consumer is to place an order for food from a food menu,
a food characteristic data provider, implemented at least partly in one or more of configurable logic or fixed functionality logic hardware, to provide food characteristic data for the food, and
an order interface to render the food menu and/or input the order.

2. The apparatus of claim 1, wherein the apparatus is to include one or more of,
a mobile computing platform that is moveable between two or more dining areas of the dining establishment, wherein the mobile computing platform is to include one or more of a hand-held mobile computing platform, a wearable mobile computing platform, or an actuator to implement a movement by the mobile computing platform, or
a fixed computing platform that is to be located at a fixed location of the dining establishment, wherein the fixed location is to include one or more of a common ordering area or a dining area.

3. The apparatus of claim 1, further including an order segmenter to segment the order.

4. The apparatus of claim 1, further including,
a service comparator to generate a comparison between the food characteristic data and food preference data, and
a menu modifier to modify the food menu based on the comparison.

5. The apparatus of claim 1, further including,
an alert identifier to identify an alert that indicates the order includes a consumer-specific disfavored food, and
an override logger to,
identify an override event for the alert by the consumer, and
log the override event in a data repository.

6. The apparatus of claim 1, further including a food allocator to associate the consumer with specific food of the order for proper allocation of the specific food to the consumer.

7. The apparatus of claim 1, further including,
a gesture identifier identify a gesture to select the consumer, and
an order linker to link specific food of the order with the consumer.

8. The apparatus of claim 7, wherein the gesture identifier is to identify a further gesture to select a further consumer associated with the consumer that is to place the order on behalf of the second consumer, and wherein the order linker is to link further specific food of the order with the further consumer.

9. An apparatus comprising:
a position indicator, implemented at least partly in one or more of configurable logic or fixed functionality logic hardware, to indicate a position of a consumer at a dining establishment via proximity data from a sensor of a personal device associated with the consumer, wherein the consumer is to place an order for food from a food menu,
a food characteristic data identifier, implemented at least partly in one or more of configurable logic or fixed functionality logic hardware, to identify food characteristic data for the food, and
a consumer comparator, implemented at least partly in one or more of configurable logic or fixed functionality logic hardware, to generate a comparison between the food characteristic data and food preference data to determine suitable food in the order for the consumer.

10. The apparatus of claim 9, further including a security determiner to determine whether a device associated with the dining establishment is to access the food preference data.

11. The apparatus of claim 9, further including an alert provider to provide an alert to indicate the order includes a consumer-specific disfavored food.

12. The apparatus of claim 9, further including an override provider to provide an override event for an alert issued to indicate the order includes a consumer-specific disfavored food.

13. At least one computer readable storage medium comprising a set of instructions, which when executed by a processor, cause the processor to:
determine a position of a consumer at a dining establishment via proximity data from a sensor of a personal device associated with the consumer, wherein the consumer is to place an order for food from a food menu;
provide food characteristic data for the food; and
render the food menu and/or input the order.

14. The at least one computer readable storage medium of claim 13, wherein the instructions, when executed, cause the processor to implement one or more of:
a mobile computing platform that is moveable between two or more dining areas of the dining establishment, wherein the mobile computing platform is to include one or more of a hand-held mobile computing platform, a wearable mobile computing platform, or an actuator to implement a movement by the mobile computing platform, or
a fixed computing platform that is to be located at a fixed location of the dining establishment, wherein the fixed location is to include one or more of a common ordering area or a dining area.

15. The at least one computer readable storage medium of claim 13, wherein the instructions, when executed, cause the processor to segment the order.

16. The at least one computer readable storage medium of claim 13, wherein the instructions, when executed, cause the processor to:
generate a comparison between the food characteristic data and food preference data; and
modify the food menu based on the comparison.

17. The at least one computer readable storage medium of claim 13, wherein the instructions, when executed, cause the processor to:
identify an alert that indicates the order includes a consumer-specific disfavored food;
identify an override event for the alert by the consumer; and
log the override event in a data repository.

18. The at least one computer readable storage medium of claim 13, wherein the instructions, when executed, cause the processor to associate the consumer with specific food of the order for proper allocation of the specific food to the consumer.

19. The at least one computer readable storage medium of claim 13, wherein the instructions, when executed, cause the processor to:
identify a gesture to select the consumer, and
link specific food of the order with the consumer.

20. The at least one computer readable storage medium of claim 19, wherein the instructions, when executed, cause the processor to:
identify a further gesture to select a further consumer associated with the consumer that is to place the order on behalf of the second consumer; and
link further specific food of the order with the further consumer.

21. At least one computer readable storage medium comprising a set of instructions, which when executed by a processor, cause the processor to:
indicate a position of a consumer at a dining establishment via proximity data from a sensor of a personal device associated with the consumer, wherein the consumer is to place an order for food from a food menu;
identify food characteristic data for the food; and
generate a comparison between the food characteristic data and food preference data to determine suitable food in the order for the consumer.

22. The at least one computer readable storage medium of claim 21, wherein the instructions, when executed, cause the processor to determine whether a device associated with the dining establishment is to access the food preference data.

23. The at least one computer readable storage medium of claim 21, wherein the instructions, when executed, cause the processor to provide an alert to indicate the order includes a consumer-specific disfavored food.

24. The at least one computer readable storage medium of claim 21, wherein the instructions, when executed, cause the processor to provide an override event for an alert issued to indicate the order includes a consumer-specific disfavored food.

25. The at least one computer readable storage medium of claim 21, wherein the instructions, when executed, cause the processor to track intake information for the food in the order.
